(19) United States
(12) Patent Application Publication
(10) Pub. No.: US 2025/0371665 A1
(43) Pub. Date: Dec. 4, 2025

(54) SUPER RESOLUTION HIGH SPEED IMAGING THROUGH APPLICATION OF STRUCTURED LIGHT PATTERNS

(71) Applicant: The Regents of the University of California, Oakland, CA (US)

(72) Inventors: Lisa Poulikakis, Oakland, CA (US); Abhishek Saha, Oakland, CA (US); Hy Cao, Oakland, CA (US); Alexander Parish, Oakland, CA (US)

(21) Appl. No.: 19/222,829

(22) Filed: May 29, 2025

Related U.S. Application Data
(60) Provisional application No. 63/653,664, filed on May 30, 2024.

(51) Int. Cl. G06T 3/4053; G06T 5/70; H04N 23/56

(52) U.S. Cl. CPC G06T 3/4053; G06T 5/70; H04N 23/56; G06T 2207/20016; G06T 2207/20048; G06T 2207/20212

(57) ABSTRACT

In some embodiments, there is provided a system configured to provide super resolution comprising a grating configured to include a plurality of openings, wherein each of the openings is subpixel in size, wherein the subpixel size is smaller than an image sensor pixel of a camera including a plurality of image sensor pixels; a slider to move the grating laterally along an image plane of the camera; an illumination source; and super resolution image reconstruction operations comprising receiving the plurality of low-resolution images; reconstructing a super resolution image using the plurality of low-resolution images, wherein the reconstructed super resolution image is noise filtered to remove noise due to in part upscaling of the plurality of low resolution images; and outputting the reconstructed super resolution image as a representation of the subject. Related systems, methods, and articles of manufacture are also disclosed.

### CROSS-REFERENCE TO RELATED APPLICATIONS

This application claims priority to U.S. Provisional Application No. 63/653,664 filed May 30, 2024, entitled “SUPER RESOLUTION HIGH SPEED IMAGING THROUGH APPLICATION OF STRUCTURED LIGHT PATTERNS”. The disclosure of which is incorporated herein by reference in their entirety.

### STATEMENT OF GOVERNMENT SUPORT

This invention was made with government support under FA9550-23-1-0263 awarded by the Air Force Research Lab. The government has certain rights in the invention.

### TECHNICAL FIELD

The present disclosure generally relates to imaging.

### BACKGROUND

Structured illumination refers to a technique that can be used to enhance the resolution of images. In the case of super resolution for example, structured illumination can be used for image resolution enhancement by illuminating a particle or an object with a patterned light (which is generated by for example a light source and a grating). The patterned light illumination of a particle or object can generate Moiré fringes that enable higher resolution image reconstruction of the particle or object.

### SUMMARY

In some example embodiments, robust and synchronized patterned illumination may be generated to enhance the spatial resolution of imaging, without the need for a microscope.

In some embodiments, there is provided a system configured to provide super resolution comprising a grating configured to include a plurality of openings, wherein each of the openings is subpixel in size, wherein the subpixel size is smaller than an image sensor pixel of a camera including a plurality of image sensor pixels; a slider to move the grating laterally along an image plane of the camera; an illumination source; and super resolution image reconstruction operations comprising receiving the plurality of low-resolution images; reconstructing a super resolution image using the plurality of low-resolution images, wherein the reconstructed super resolution image is noise filtered to remove noise due to in part upscaling of the plurality of low-resolution images; and outputting the reconstructed super resolution image as a representation of the subject.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example of a system for super resolution imaging using structured illumination, in accordance with some embodiments;

FIG. 1B depicts a configuration of an imaging plane of the system of FIG. 1A, in accordance with some embodiment;

FIG. 1C depicts the system during super resolution image reconstruction processing operations, in accordance with some embodiments;

FIG. 2 depicts an examples of a grating, registration landmarks, and pattern alignment, in accordance with some embodiments;

FIG. 3 depicts an example of a process for super resolution imaging reconstruction using structured illumination, in accordance with some embodiments;

FIG. 4 depicts super resolution image reconstruction of a dynamic flow, in accordance with some embodiments; and

FIG. 5 depicts another example of a system, in accordance with some embodiments.

### DETAILED DESCRIPTION

In flow imaging applications, intensity gradients are often a good measure of scalar gradients, which can play a role in controlling transport processes (e.g., movement of the particles or mass within a material). But current resolution enhancement techniques for flow imaging with system-limited spatial resolutions are not well investigated. As such, there are provided systems, methods, and articles of manufacture for structured illumination based flow imaging that may be used to enhance pixel resolution and/or estimation of scalar gradients in flow imaging. In some embodiments, the sub-pixel-scale patterned light (which is generated by a grating) is used to enhance the imaging resolution of the camera. Moreover, multi-frame images over time may be used to create quasi-static images over a plurality of frames (e.g., two, three, four or more frames), with scalability for high-speed imaging, for example. The multi-frame images may be processed, in accordance with some embodiments, using a recombination algorithm and/or a noise reduction algorithm to produce a new, high-resolution image with for example twice the pixel resolution compared to the original image.

In some embodiments, there is provided a synchronized, structured illumination (e.g., using a grating with a pattern) that is generated to enhance spatial resolution of imaging, without the need for a microscope, for example. Spatial resolution refers to a level of detail an image can capture that is determined in part by the quantity of pixels used to create the image.

To illustrate with an example application of the disclosed subject matter, there may be provided spatial resolution enhancement in flow imaging captured by a camera, such as a high-speed camera (although other types of imaging sensors and/or cameras may be used as well). Flow imaging refers to flow imaging methods (also referred to as “dynamic image analysis”) that are used to capture images of subvisible and/or visible patterns (created by microorganisms or other types of particles, such as dust, smoke, and/or the like, differences in densities, and/or refractive index of two media) in for example a medium.

In some embodiments, there is provided a system that provides synchronization of a grating (e.g., having a pattern of openings) to a camera. For example, a light source may be positioned on one side of the system to generate light and thus provide structured illumination on a subject being imaged. The system may be aligned to a camera (and/or other type of imaging sensor) placed facing the opposite side of the light source. The subject, such as an object(s), particle(s) and/or the like in a medium (e.g., a gaseous medium or glass slides) is placed in between the light source and the camera, such that the subject can be imaged. The grating (which has a pattern of openings to allow light to pass through the grating's openings) filters incoming light from the light source to generate a pattern (providing, e.g., structured illumination). The grating's pattern is configured based on for example the camera and/or subject to be imaged (e.g., the pixel size of the camera may be used to configure the size of the grating's openings or pattern). Each dot of light (which is projected through openings forming the pattern in the grating) may for example cover a quarter of a camera's image sensor pixel.

In operation, the grating may be controlled such that a slider (also referred to as a “grating slider”) moves the grating laterally across the imaging plane (and, e.g., back again), wherein the movement is under the control of electronic circuitry, for example. This grating movement may be synchronized with a connected camera, such as a high-speed camera, to ensure each position (which is caused by the lateral movement) is captured as a low-resolution image (e.g., a frame) by the camera (which is stationary). The system may be configured such that the subject (which is being imaged) is placed in close proximity to the patterned grating and/or the light source. To illustrate further with an example, the grating's lateral movement may be configured to move at least 25 millimeters per second (with, for example, an accuracy of 1 millimeter vertical movement over a 100 millimeter length). This accuracy may enable a minimum of 1000 frames per second of imaging at a movement speed of 25 millimeters per second assuming movement between each frame is 25 micrometers. The resulting set of N low resolution images (e.g., a 400 pixel by 400 pixel with a pixel scale of 50 micrometers) may be combined using an super resolution image reconstruction algorithm (e.g., using software-based algorithms) that extrapolates information per pixel based on the grating and that superimposes the low resolution images onto a high resolution image (e.g., a 800 pixel by 800 pixel with a pixel scale of 25 micrometers). Since each high-resolution image is created from four low resolution images for example, the result is N minus 3 high resolution images (e.g., 4 low resolution images result in 1 high resolution image). As used herein, a low resolution image refers to an image captured by a camera (or corresponding image sensor) having a lower resolution with respect to pixels, when compared to a high resolution image generated in accordance with the super resolution reconstruction algorithm disclosed herein.

Moreover, the grating and light source may be adjusted (e.g., tuned, focused, etc.), such that the spots of light projected by the grating's pattern are for example evenly spaced and result in structured illumination (or light) covering a quarter (¼) of the camera's pixel.

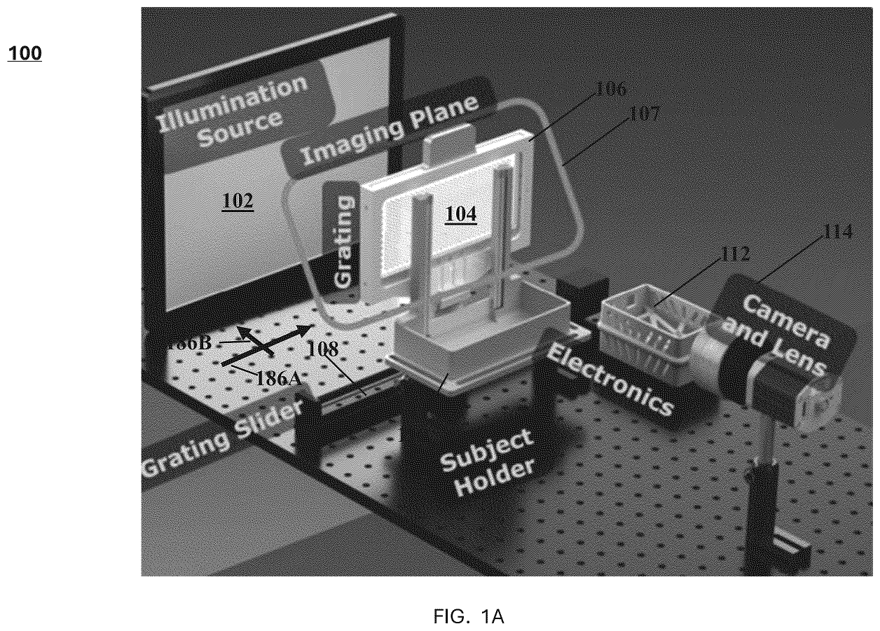

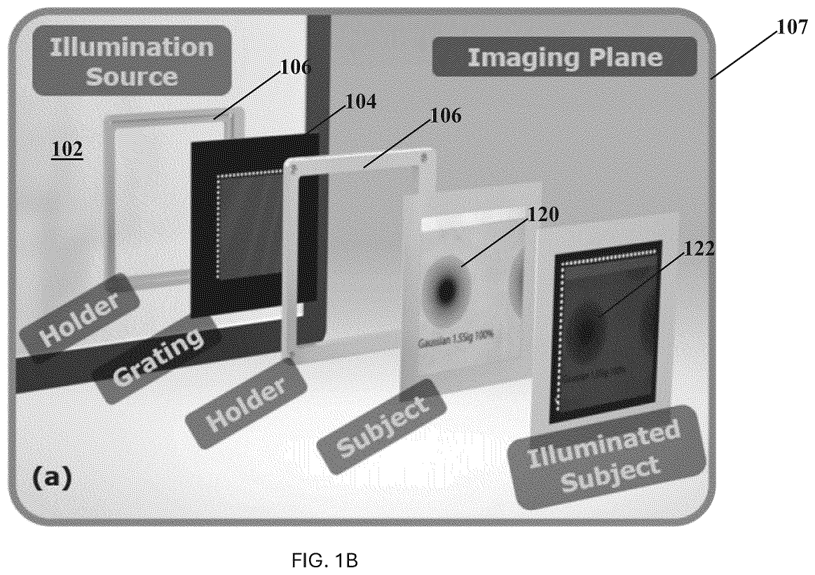

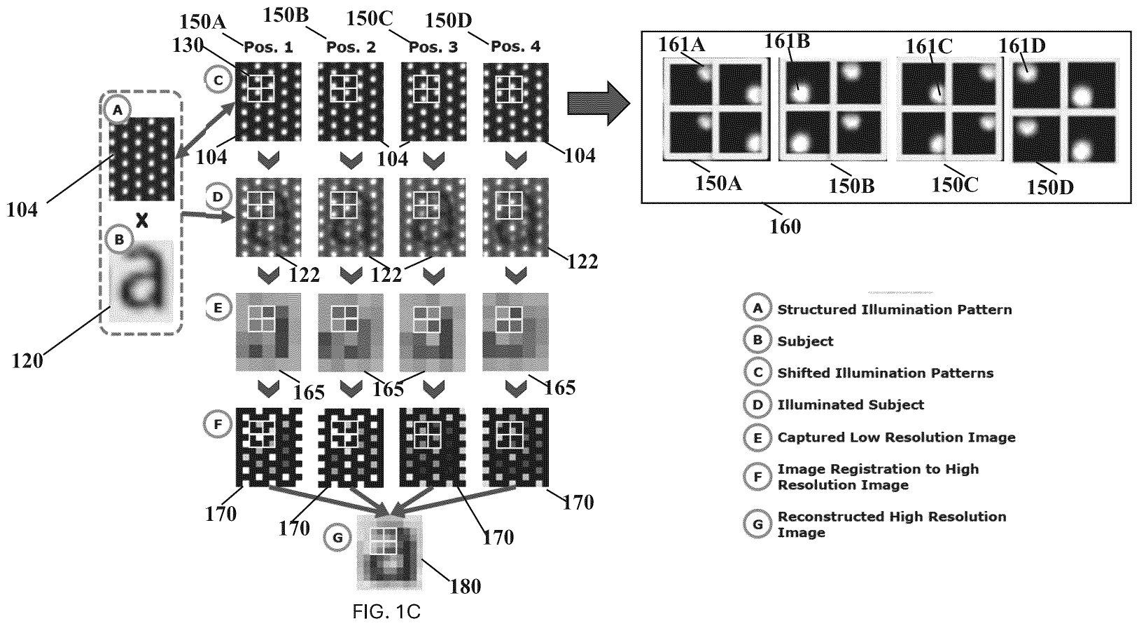

FIG. 1A depicts an example of a system 100 for super resolution imaging using structured illumination, in accordance with some embodiments. FIG. 1B depicts a configuration of an imaging plane 107 of the system 100.

Referring to FIGS. 1A-1B, the system 100 includes an illumination source 102 (also referred to a light source) configured to provide light to illuminate the subject 120, such as a particle, an object, flow of particles, and/or the like, being imaged. The illumination source may be any type of light source including for example light emitting diodes, laser light sources, and/or other types of light sources.

The system 100 further includes a grating 104. The grating is configured to provide structured illumination (also referred to as structured light) towards the subject 120. In some embodiments, the grating is configured to have openings that allow structured light (from the illumination source 102) to pass to the subject. In some embodiments, the openings are patterned such that the grating's openings are each sub-pixel in size (e.g., smaller than the pixels of the camera 114). For example, each of the grating's openings may be a quarter (¼) of the size of a pixel of the imaging sensor. Moreover, the camera may be implemented as any type of imaging sensor including a high-speed camera (e.g., a camera configured to capture images with short exposures, such as 1/30^{th} of a second (or smaller), and/or frame rates exceedingly at least 30 frames per second).

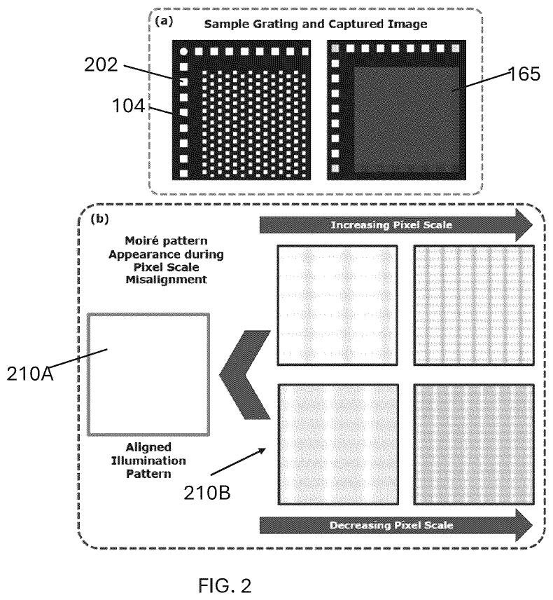

To illustrate further, the grating 104 may be configured as a hexagonal lattice grating (see also FIG. 2 at 104). The hexagonal lattice grating includes a plurality of openings (which are for example squares or circles) configured in a hexagonally based periodic pattern. In some embodiments, the distance between the centers of adjustment for the hexagonally spaced openings is 10 to 500 micrometers (which refers to the grating period).

In some examples, the grating 104 may be configured with 105 μm sized openings (e.g., square or other shaped openings spaced 352 μm apart from, e.g., center of opening to center of adjacent opening). Alternatively, or additionally, the grating may be configured with 212 μm sized openings spaced 424 μm apart, although other grating configurations may be implemented as well

The system 100 may also include a grating holder 106 configured to hold the grating 104. In some embodiments, a grating slider 108 mechanically moves the grating 104 (including the grating holder 106) laterally 186A back and forth to image the subject while the camera 114 and the subject 120 remains fixed (relative to the grating). As noted, the grating slider may be under the control of electronic circuity 112 which also signals the camera 114 that the slider has moved to a position, so the camera can take an image of the subject (illuminated with the structured light/illumination). Moreover, the grating's lateral movement may be, as noted, configured to move at least 25 millimeters per second back and forth laterally 186A across the imaging plane 107. FIG. 1A depicts the lateral direction 186A, which is perpendicular 186B to a plane formed by the illumination source 102.

In the example of FIGS. 1A-1B, the subject 120 is positioned between the grating 104 and the camera 114, so the subject is within the imaging plane 107. As shown at FIG. 1B, the subject 120 is illuminated with structured illumination (light) formed by the patterned openings of the grating 104 to form an illuminated subject 122. This illuminated subject is imaged or formed on the camera's 114 imaging sensor pixel(s) and thus detected by the camera 114.

The system 100 may also include, or be coupled to, electronic circuitry 112. For example, the electronic circuitry may include at least one processor (e.g., one or more microprocessors, CPUs, etc.) and at least one set of memory storing instructions, such that when the instructions are executed by the at least one processor, operations are provided, such as some (if not all) of the super resolution image reconstruction processing operations disclosed herein (see, e.g., FIGS. 1C, 3, 4, and the like). The electronic circuitry 112 may further include a motor controller. The electronic circuitry 112 may also include optical sensors and/or electromechanical switches.

FIG. 1C depicts the system 100 during super resolution image reconstruction processing operations, in accordance with some embodiments. When the camera 114 captures the low resolution images of the subject 120, the super resolution image reconstruction processing algorithm may align (e.g., registers) images, recombine the images, reduce noise in the images (e.g., using phase differences in the Fourier domain), and generate a final high resolution image with for example four (4) times the spatial resolution of the original low resolution images captured by the camera.

In the example of FIG. 1C, the grating 104 and the subject 120 (which in this example is the letter “a” although the subject may take other forms as well) are shown.

At a first position 150A (labeled Pos. 1), the grating 104 is in a first position. In other words, the grating slider 108 moves laterally 186A to place the grating in the first position. The camera 114 is in a fixed position relative to the grating 104. The 2×2 grid 130 (which is overlaid on the grating 104) is depicted to illustrate four image sensor pixels at the camera's 114 imaging sensor (in other words, what the 4 image sensor pixels capture or see, although the camera may and likely does include additional image sensor pixels to capture the other portions as well). As noted above, the grating 104 provides sub-pixel structured illumination. In the example of FIG. 1C at the first position 150A, the grating 104 illuminates sub-pixel areas (as illustrated by the white dots in the grid 130) of the imaging sensor of the camera.

As the grating 104 moves laterally 186A across the field of view of the camera 114 from the first position 150, to the second position 150B, the third position 150C, and the fourth position 150D, the grating 104 illuminates (as indicated by the white dots) four different portions of a given image sensor pixel. At 160, there is shown a closer view of the grating's illumination of the image sensor pixels as it moves from the first position 150A to the fourth position 150D. Referring to the top left grid 161A-161D (which represents a single image sensor pixel), the opening in the grating illuminates the top right corner of the image sensor pixel in the first position 150A, illuminates the bottom left corner of the image sensor pixel in the second position 150B, the bottom right corner of the image sensor pixel in the third position 150C, and the top left corner of the image sensor pixel in the fourth position 150D. In this way, the ¼ subpixel sized gratings takes 4 samples to capture the subject.

Although some of the examples refer to the grating opening as ¼ the size of the image sensor pixel, this is merely an example as the grating opening may take other sizes as well. For example, using a grating opening that is smaller than ¼ the size of the pixel scale may be implemented to take into account the spread of light. A pixel may also be divided into 9, 16, or more square divisions that allow for the grating openings to be 1/9 or 1/16 the size of the image sensor pixel scale.

FIG. 1C also shows the illuminated subject 122 (which in this example is the “a” as shown) as the grating 104 moves laterally 186A from the first position 150A to the fourth position 150D, while the sub-pixel structured illumination of the subject 120 changes accordingly as shown. The illuminated subject 122 is captured (e.g., detected) by image sensor pixels of the camera 114. The corresponding images, from the first position 150A to the fourth position 150D, are depicted at 165.

The images 165 are considered “low resolution images” as the images have not been image processed with super resolution image reconstruction to enhance their resolution. To enhance the resolution of the images 165, a super resolution image reconstruction processing algorithm may be used to register images, recombine the images, reduce noise in the images, and generate a final high resolution image with for example four (4) times the resolution of the original, low resolution images captured by the camera. The increase in spatial resolution is directly attributed ¼ sub-pixel resolution. At 170, registered images are depicted, wherein the registered images may be used to reconstruct a final high-resolution image of the subject as shown at 180.

Moreover, the grating 104 may include one or more structures that can be captured by the low-resolution image. These structures (also referred to herein as registration landmarks) may be placed in the grating so the registration landmarks appear in the captured images. FIG. 2 depicts an example of the registration landmarks 202 along the perimeter of the grating and shows the same registration landmarks in the captured image 165. As noted, the registration allows a plurality of images to be aligned.

Referring again to the grating holder 106, it may sandwich the grating 104, such that the grating holder 106 is coupled to the grating slider 108, although the grating may be coupled to the grating slider in other ways as well. The grating slider may include a motor, such as a stepper motor, and may be under the control (e.g., with respect to lateral movement) of the electronic circuitry. Specifically, the stepper motor may be used to move the grating holder and grating along the grating slider (implemented with, e.g., a millimeter linear guide and rail assembly) to provide controlled automated movement.

Before providing additional description regarding the use of a grating to provide sub-pixel structured illumination to enable super resolution high speed imaging, the following provides additional description regarding super resolution (SR) techniques, optics, and imaging.

Any given imaging system has its spatial resolution constrained by either the diffraction of light or optical and hardware limitations. The former is often a major concern in biological imaging with high-magnification microscopes, where pixel sizes are well beyond the lower bound of the spatial resolution and result in over-sampled images with blurry unresolvable detail. The latter is more often the case and seen in systems such as in consumer phones or high-speed cameras where the physical constraints of sensor manufacturing and optics mean the spatial resolution is simply the pixel size and creates under-sampled images. In both scenarios, the enhancement of spatial resolution is paramount to a better analysis and understanding of static and dynamic phenomena. Over the last few decades, myriad techniques have been developed under the umbrella of super resolution (SR, which refers to techniques to enhance the resolution of images) to overcome inherent limitations in imaging, including spatial resolution for better analysis of various phenomena.

Standard super resolution techniques may feature a trade-off between spatial and temporal resolution requiring multiple lower resolution (LR) images to reconstruct a high resolution (HR) image containing information not readily seen in the lower resolution frames. This enhancement often comes from extractable information that is not inherently accessible from a single image but is obtainable through a set of images, where each image contains unique and definable information from changes in the illumination, subject, or optical train. Super resolution techniques may be divided into diffraction-limited and system- or instrument-limited systems.

With respect to diffraction-limited techniques, these types of system operate by enhancing a minimum resolvable spatial frequency that exists beyond that of the original image. These diffraction-limited systems may use structured illumination (SI) to generate for example Moiré fringes (which folds high into low-order spatial frequencies that can be shifted and extracted in Fourier space).

With respect to instrument-limited systems, minimum resolvable features pertain to the sensor pixel density and optical magnification. Up until the diffraction of light, subject detail and information still exists that various approaches utilizing sensor pixel-shift (subject micro-scanning, or source illumination variation) can extract. These approaches may define system information with reference to each captured image to resolve information past system limits. Algorithmic processing may also be used for additional resolution enhancement.

Image reconstruction and enhancement may be aided by computationally heavy algorithms, such as processes based on machine learning models (e.g., neural networks and/or the like). The extraction of information without using a large set of images (or even within a single image) using structured light may be realized. But despite this, informational accuracy remains a function of the captured image with inherent limits to reconstructed image enhancement through computation, so there is a need for a physical system that obtains images with higher resolution prior to algorithmic, image processing computational enhancements.

In an optical train, there may be two idealized lateral spatial resolution limits. A physical diffraction limit determined by the optics and the resulting diffraction of light, and by a mechanical limit determined by the camera pixel size and optical magnification. The former is tied to the airy disk (e.g., the smallest circle that an incoming point source of light can form through an aperture dictated by diffraction). The latter mechanical limit exists when the pixel size is well above the diffraction limit, which results in a system limitation. This may be defined by the Nyquist-Shannon sampling criterion, in which the minimum sampling frequency to resolve a feature must be twice that of the size of the smallest desired feature to sample. In practice, it is common to use a minimum of 2.3 times the minimum feature frequency to overcome noise from system imperfections.

With respect to diffraction-limited systems (where the sampling rate is well above the Nyquist-Shannon criterion), a minimum separation distance between two airy disks (while each still being distinct) results in a spatial resolution limit. The Abbe limit and Rayleigh criterion may be used to define the minimum separation distance based on the airy disks. While these formulas are functionally similar, the Abbe limit is based on a full width half maximum between two airy disks while the Rayleigh criterion is based on the distance from the center to the first minimum of the airy disk. These values d_{Abbe} and d_{Rayleigh} are both defined by the numerical aperture (NA) and the wavelength λ of light and shown in Eq. (1) and Eq. (2) below:

$${d}_{Abbe} = \frac{0.5 λ}{NA} - \frac{0.5 λ}{n sin ( θ )} \qquad ( 1 )$$

$${d}_{Rayleigh} = \frac{0.61 λ}{NA} = \frac{0.61 λ}{n sin ( θ )} \qquad ( 2 )$$

wherein NA=nsin(θ) is the numerical aperture (NA) of an imaging objective lens, λ is the wavelength of light, n is the refractive index of the surrounding medium, and θ is ½ the collection angle of the objective lens.

The pixel pitch is defined as the distance between two pixels on a sensor (e.g., an imaging sensor), and the pixel size is defined as a physical distance captured by a pixel. The relation between the pixel pitch and pixel size is defined in Eq. (3) as follows:

$$Pixel Size = \frac{Pixel Pitch}{Optical Magnification} \qquad ( 3 )$$

wherein optical magnification refers to the ratio of the size of an image with respect to the size of the original object.

For imaging setups where the pixel size is much larger than the diffraction limit, spatial resolution (tied to the pixel size and any spatial resolution enhancements) is achieved through decreasing the pixel pitch or increasing the optical magnification. For most cameras for example, sensor manufacturing may be at physical limits, so decreasing pixel pitch may not be achieved by trivial means. Conversely, increasing the optical magnification is possible, but causes a decrease in the field of view and axial spatial resolution. When considering a high-speed imaging setup for dynamic phenomena for example (where sensor and optics may not be easily changed), enhancement through super resolution techniques may be considered.

With respect to lateral spatial resolution, a process, in accordance with some embodiments, may start with any given pixel. This pixel is sub-divided at the imaging plane into an x-by-x square grid (see, e.g., grid 130 at FIG. 1C). Next, each sub-division of the pixel is illuminated (e.g., with a spot of light received from a grating) consecutively. A series of images is captured, wherein the images correspond to each illuminated sub-divided pixel. The captured series of images results in x² images, with intensity information that can be mapped spatially to the x-by-x grid (as the illumination position is known or determinable). This enables the pixel scale to be halved, so this doubles the image resolution of the image in lateral vertical and horizontal spatial directions, for any given pixel. The in-plane vertical and horizontal directions on the image as opposed to the in and out of plane axial direction.

Expanding this across the entire field of view of the image creates a sub-pixel scale structured illumination pattern and allows for spatial resolution enhancement by a factor of x for the entire image-resulting in for example a 2D periodic lattice. For each spot in the 2D lattice, the spot size (or pitch) at the imaging plane may be at most the size of a single sub-division of a pixel as defined in by Eq. 4:

$${D}_{SIspot} = \frac{Pixel Pitch}{x} \qquad ( 4 )$$

wherein D_{SIspot} is the pitch of the hole on the sub pixel grating and x is number of subdivisions of the pixels.

By shaping the grating's structured illumination pattern into for example a hexagonal lattice of openings, there is provided full coverage of a pixel at each subdivision through a linear translation of the resulting grating with a shift per frame of the structured illumination spot size diameter D_{SIspot}. The grating is configured to match a given pixel scale of a given optical setup (e.g., the size of the image sensor pixels), so changes in the pixel scale in a system may dictate a change to the grating.

To expand utilization of patterned light for dynamic processes, a grating having a sub-pixel pattern (which provides the structured illumination pattern) may be used to enable resolution enhancement of images and, in particular, enhance lateral spatial resolution of consecutive images. Moreover, the super resolution image reconstruction processing software based algorithm may be used to register images, recombine the images, reduce image noise (e.g., using phase difference in the Fourier domain), and generate a final high-resolution image with for example four (4) times the resolution of the original, low-resolution images captured by the camera.

FIG. 2 shows at (a) an example of a grating 104 with a captured image 165 (e.g., captured by a camera) that shows no visible sub-pixel pattern. The grating 104 also shows an example of registration landmarks 202. The registration landmarks allow alignment over a plurality of images using the common (or shared) registration marks. The registration landmarks allow images to be aligned, which reduces noise when images are combined.

To effectively image with a sub-pixel grating such as the grating 104, the sub-pixel pattern alignment to the camera 114 image sensor pixels is controlled and maintained using the grating slider 108 and electronic circuitry 112. As the individual illumination spots from the grating cannot be detected, the registration landmarks 202 are placed to allow for spatial definition of the lighting. These registration landmarks 202 also serve to align the rotation, tilt, and starting position of the structured illumination pattern to the imaging plane and the camera (or, e.g., camera's image sensor(s)).

Moreover, a registration structure having a known structure (e.g., openings, dots, landmarks, or other visual items around the periphery of the grating) may be used to register images over time and/or across frames. The registration may be used during image processing to reduce noise when recombining images.

FIG. 2 also shows at (b) an example of a Moiré pattern occurring (1) when the system's image sensor pixel size does not match (at 210B) the grating and (2) when the image pixel and grating are aligned (at 210A). Referring to FIG. 2 at (b), a Moiré effect occurs when the sub-pixel grating pattern is not perfectly scaled to the camera sensor. Specifically, FIG. 2 at (b) shows this effect as the pixel scale becomes larger or smaller than that of the grating (as both the pattern and the sensor may considered as a set of 2D gratings). When these gratings are perfectly matching, the frequencies of the two align and light shining through generates a flat intensity profile as shown at 210A. As the pixel size of a system changes due to optical changes, a frequency mismatch occurs resulting in lower order frequencies appearing as a Moiré pattern in the image as shown at 210B. This can be utilized to optically align the system 100.

Referring again to the fluid flow (and other dynamic applications) example noted herein, a set of n1 greater than (>) x² (1, 2, . . . , n1) images may be captured by the system 100. Each successive set of x² images may be combined to create a set of n1−(x²−1) reconstructed high resolution images. That is, a first reconstructed high-resolution (rHR) image contains captured low-resolution (clerk) images 1 through 1+(x²−1), the second high-resolution image contains images 2 through 2+(x²−1), through the final possible reconstructed high-resolution image containing captured low-resolution images n1−(x²−1) through n. The maximum subject movement between any x² number of frames should be smaller than the spatial resolution of the reconstructed high resolution images defined as

$${U}_{subject}^{max}$$

in Eq. (5) below. This may ensure quasi-static images, otherwise temporal aliasing will occur and provide poor data. For a linearly driven grating shifting the structured illumination pattern, the grating is driven at a velocity U_{grating} as defined in Eq. 6 below:

$${U}_{subject}^{max} <= \frac{Pixel Size * Frame Rate}{{x}^{2}} \qquad ( 5 )$$

$${U}_{grating} = \frac{Pixel Size * Frame Rate}{x} \qquad ( 6 )$$

wherein

$${U}_{subj ect}^{max}$$

is the maximum allowable velocity of the subject, U_{grating} is the velocity of the grating, and x is the number of pixel subdivisions.

While simple image reconstruction is possible through quantification of the sub-pixel scale illumination and superimposing pixels from a captured low-resolution (LR) image onto a reconstructed high resolution grid, imprecise alignment (with respect to the structured illumination pattern) adds an additional source of noise. As such, there is provided noise reduction, in accordance with some embodiments. The noise reduction may reduce the features in the image that correspond to noise that exists at different (e.g., spatial) frequencies compared to that of the features in the image that are desired. Information that is found to be different is altered by an upscaled version of the low-resolution image. This enables preserving the upscaled information at the desired scale, while minimizing the enhanced noise at other scales.

To that end for example, a variation of a frequency domain phase-based projection onto convex sets (FPPOCS) SR algorithm may be used. Specifically, the noise reduction algorithm relies on a difference between the representation of real space information in the Fourier space amplitude and phase spectrum. Textures and structures in real space are represented by a phase spectrum and are utilized to separate features. Since the noise (which results from the structured illumination pattern and its shifts) move at a faster rate than the subject (e.g., the flow) being imaged, the noise structures (from the structured illumination) differ greatly from that of the subject or flow. And, the noise structures (from the structured illumination) have a consistent nature between frames, the differences in the phase domain (which is determined in the Fourier domain) may be used to apply noise filtering that filters out the noise introduced by the imperfections in the illumination patterns and the mechanical alignment and movement of the grating as well as other unwanted sources of noise to the image.

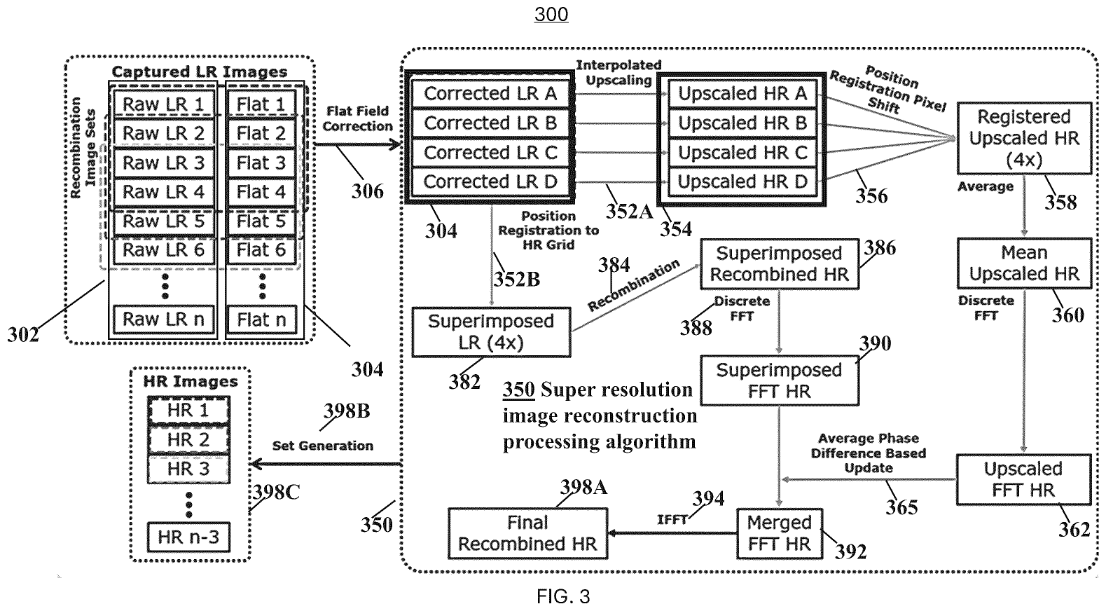

FIG. 3 describes an example of a process 300 for super resolution imaging using structured illumination, in accordance with some embodiments.

The process receives, at 302, a plurality of low-resolution images captured by for example a camera, such as camera 114, although other types of image sensors including high-speed cameras may be used as well. For example, the camera 114 may capture a plurality of low resolution images (labeled Raw LR 1 through N), such as the images 165 depicted at FIG. 1C.

At 304, the low-resolution images may be corrected for flat field. For example, the low-resolution images received at 302 may be corrected for flat field in order to compensate the low-resolution images for non-uniformities, such as vignetting, pixel-to-pixel variations caused by the illumination source, and/or the like.

Next, the flat field corrected low-resolution images are provided, at 306, to a super resolution image reconstruction processing algorithm 350. These flat field corrected low resolution images 304 are processed in two image processing chains 352A and 352B.

The first chain, at 352A, takes the plurality of low resolution images (which have been as noted flat field corrected and registered) and forms a plurality of high resolution images using upscaling interpolation of each low resolution image (e.g., adding pixels to the low resolution image, where the added pixels are based on the surrounding pixels' values). For example, the low-resolution images may be upscaled by a factor of 2 (although it may be upscaled by other factors as well) in the vertical and horizontal directions to form upscaled high resolution images 354.

The second chain at 352B uses a high-resolution grid to recombine the low-resolution images. This second chain is the base image that gets utilized for the high-resolution reconstruction. The noise reduction that takes place replaces information in this second chain with information from the first.

Referring again to the first chain and in particular 356, the upscaled high resolution images 354 may be registered to align their position. For example, the registration landmarks in each low-resolution image may be used to align the upscaled high-resolution images 354. The landmark registration on each image may be used to shift each image so the landmark registrations match.

Once aligned, the upscaled high resolution images may be combined, at 358. For example, the registered, upscaled high resolution images may be averaged and then a Fourier Transform (e.g., a discrete Fast Fourier Transform (dFFT) of the average may be performed at 360, so a frequency domain representation of the high resolution upscaled image is formed at 362.

At 365, the frequency domain representation is processed to reduce noise in the high-resolution image. When the Fourier transform of an image is performed, the phase information and, in particular, phase differences may be used to distinguish and thus filter out noise introduced by interpolation from noise introduced by the grating and illumination. Specifically, the differences in information between the desired information and noise as a result of this setup can be separated.

Referring again to 304 and the second chain at 352B, the low-resolution images may be registered at 380 to align the corrected low-resolution images to a high resolution (HR) grid. For example, the low-resolution images are mapped into the HR grid, such that interpolation is used to fill in any gaps between pixels in the HR grid (so the HR grid serves as a structure to reconstruct the high-resolution image). Next, the low-resolution images are superimposed at 382 and recombined at 384 to form a single high-resolution image 386. Referring again to 304 and the second chain at 352B, the low-resolution images may be registered at 380 to a high resolution (HR) grid. For example, the low-resolution images are mapped into the HR grid, such that every pixel in the low resolution image has a specified location on the HR grid (so the HR grid serves as a structure to reconstruct the high resolution image). This creates the set of four super-imposed low-resolution images at 382. Next, the low-resolution images are recombined at 384 to form a single high resolution image 386.

Next, a Fourier Transform (e.g., DFFT) of the single high-resolution image 386 is performed to yield a Fourier domain representation of the high-resolution image 390.

At 392, the Fourier domain representation of the high-resolution image 390 and frequency domain representation of the image (which is noise reduced at 365) is merged at 392 to form a merged high-resolution image in the frequency domain. The majority of the information comes from 390, 362 is used to replace any information found to be noise in 390.

At 394, an inverse Fourier Transform (e.g., inverse Fast Fourier Transform (IFFT)) may be performed on the merged, Fourier domain high-resolution image of 392 to form the final recombined high-resolution image 398A. After repeating this process for every four images in the entire set at 398B, this set generation then results in 398C with the resulting number of high-resolution images being n−3, where n is the total number of low resolution images first used.

Referring again to the flat field correction 306 of FIG. 3, for each low-resolution image 302 for example, a near identical image is captured without a subject but identically similar in other mechanical aspects, which is considered a flat field F. Similarly, dark current images D and FD are captured for the low-resolution and the flat field F, respectively. A flat field corrected LR image is obtained by performing a flat field correction for every image as defined by Eq. (7):

$$ffcLR = \frac{( cLR - D ) * m}{F - FD} \qquad ( 7 )$$

$$m = mean ( cLR - D ) \qquad ( 8 )$$

wherein ffcLR is the flat field corrected low resolution image, cLR is the captured low resolution image, d is the dark current image, F is the flat field image, FD is the dark current image for the flat field, and m is the averaged mean intensity of the corrected low resolution image after dark current subtraction.

Referring again to the registration noted above with respect to FIG. 3, the registration landmarks, such as registration landmark 202 (or other visible artifact or item), may be used to align the images. By using registration landmark 202 structures placed along the border of the structured illumination pattern for example, the position of every image is registered (e.g., aligned) in a set relative to a single origin framework defined by the registration landmarks.

As noted above, the low-resolution images 304 are processed in two image processing chains. The first chain 352A uses interpolation (e.g., adding pixel values based on for example values of neighboring pixels) to upscale the low-resolution images to high-resolution images, while the second chain 352B superimposes the low-resolution images using an HR grid (so they only contain the original low resolution images) to form high-resolution images. This second chain is the base image that forms the high-resolution image with the second chain generating an image to be used to replace information found to be noise.

To generate the superimposed HR image at 386, a high-resolution grid (which contains x times the number of pixels in both lateral axes compared to the flat field corrected low-resolution image) is generated. For each flat field corrected low resolution image, each pixel (based on the known position and structure of the sub-pixel SI pattern) is superimposed onto this high resolution grid. This is a geometric reconstruction with no noise filtering and only information from the base set of captured low-resolution images that we define as the preliminary HR image X₀.

To interpolate at 352A low-resolution images to form a high-resolution image, the following is performed. For each flat field corrected low-resolution image, the image is resized by a factor of x through an interpolation (e.g., a bicubic interpolation); next, each image is aligned spatially, and the average of all the images is taken to obtain an estimated high-resolution image Xₑₛₜ.

With respect to Fourier Transforms, each image may be cropped to contain only the region of interest covered by the sub-pixel scale structured illumination pattern. With respect to the Fourier Transform, a discreet Fourier transformation may be applied. Alternatively, or additionally, a padded zero discreet Fourier transformation (pDFT) may be applied to each cropped image to obtain the cropped Fourier high-resolution image.

With respect to noise reduction in the phase domain (which is obtained using the Fourier Transform of an image), the phase spectrum is used to obtain an absolute difference of the phase angle between the two discrete Fourier Transforms for each wavenumber Δφ. m_{Δφ} is then the mean of all values in Δφ as defined in Eq. (10) and Eq. (11). For values greater than m in Δφ, the phase angle of that wavenumber in \tilde{X}₀ with the phase angle in \tilde{X}ₑₛₜ. This comparison is defined in Eq. (12).

$$Δφ = \vert φ {x}_{0} - φ {x}_{\text{?}} \vert \qquad ( 10 )$$

$${m}_{Δφ} = \frac{1}{MN} {\sum }_{i = 1}^{N} {\sum }_{i = 1}^{M} Δφ \qquad ( 11 )$$

$${\tilde{X}}_{final} = {A}_{{x}_{\text{?}}} \{ \begin{matrix}{e}^{i \text{?} {x}_{\text{?}}} & if Δφ > {m}_{Δφ} \\ {e}^{i φ {x}_{\text{?}}} & else\end{matrix} , \qquad ( 12 )$$

$$\text{?} \text{indicates text missing or illegible when filed}$$

wherein Δφ is the absolute difference between the phase angles of the two images, φX₀ represents the phase angles of the superimposed image, φXₑₛₜ is the phase angles of the interpolated image, m_{Δφ} is the mean value of the absolute difference between the phase angles, M and N are the size of the padded image in the horizontal and vertical directions respectively, \tilde{X}_{final} is the final image in Fourier space, and A_{X0} represents the magnitudes of the superimposed image in Fourier space.

With respect to the grating slider, the grating slider may be synchronized to the camera. For example, the linear or lateral positioning of the camera 114 may be synchronized to the grating slider and coupled grating. As explained with respect to FIG. 1C for example, at each of the positions (e.g., the first position, second position, third position, and fourth position), the grating slider and grating may stop to enable the camera to capture at least one low resolution image (e.g., a frame) before moving to the next frame.

In some implementations, the camera imaging may be at frame rates over 250 frames per second. When this is the case, the synchronization ensures that the camera takes an image exactly when the grating is at a correct location, such as the first position. To that end, a linear stage (coupled to a stepper motor) moves the grating slider including the grating into each position. The position of the linear stage is then determined or read by for example a linear quadrature encoder. This encoder's quadrature signal is read by multiple quadrature encoder counters, one of which is programmed to send a clock signal (also referred to as a trigger signal) to the camera to trigger the image capture.

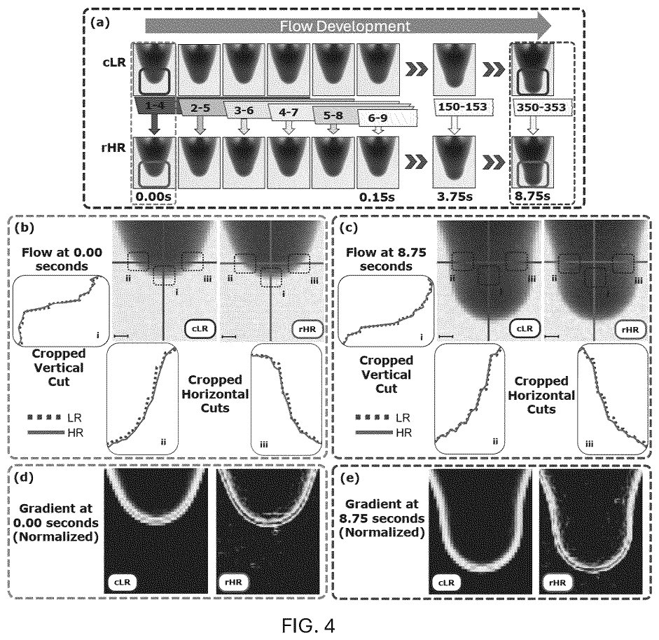

FIG. 4 shows an overview of the recombination of a set of images captured as a flow developed. FIG. 4 at (a) shows how the set of captured low resolution and reconstructed high-resolution images (with labels denoting which frames are utilized to create a high-resolution image for flow developing over 8.75 seconds). FIG. 4 at (b) and (c) show a zoomed in image of the flow at 0.00 and 8.75 seconds respectively with corresponding line-cuts showing an increase in the pixel resolution. In the drawings, scale bars are 1.76 mm. FIG. 4 at (d) and (e) show flow gradient magnitudes of the flow both before and after reconstruction at 0.00 and 8.75 seconds respectively. The gradients are normalized per mm.

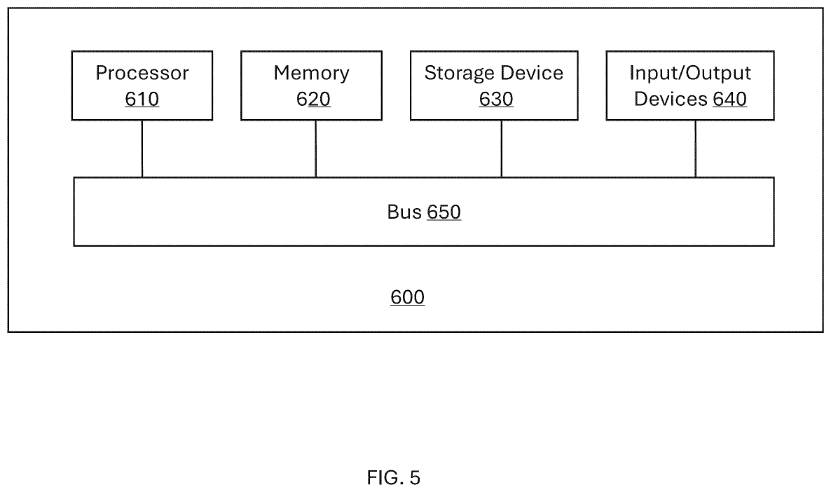

FIG. 5 depicts a block diagram illustrating a computing system 600 consistent with implementations of the current subject matter. Referring to FIGS. 1-5, the computing system 600 can be used to implement the processes (e.g., at FIG. 1C, FIG. 3, FIG. 4, and/or the like). Alternatively, or additionally, the computing system 600 may be comprised at least in part in the electronics circuitry 112. Alternatively, or additionally, the computing system 600 may be coupled to the system 100.

As shown in FIG. 5, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, the configuration engine 110. In some implementations of the current subject matter, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a solid-state device, a hard disk device, an optical disk device, and/or any other suitable persistent storage means. The input/output device 640 provides input/output operations for the computing system 600. In some implementations of the current subject matter, the input/output device 640 includes a keyboard and/or pointing device. In various implementations, the input/output device 640 includes a display unit for displaying graphical user interfaces.

According to some implementations of the current subject matter, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any non-transitory computer readable storage medium, program product, apparatus and/or device, such as for example magnetic discs, optical disks, memory, and Programmable Logic Devices (PLDs), used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles of manufacture depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
a grating configured to include a plurality of openings, wherein each of the plurality of openings is subpixel in size, wherein the subpixel size is smaller than an image sensor pixel of a camera;
a slider coupled to the grating and configured to move the grating laterally along an image plane of the camera;
an illumination source, wherein the illumination source generates light that passes through the grating to form structured illumination configured to provide sub-pixel sized structured illumination on a subject as the grating moves laterally along the image plane to enable the camera to capture a plurality of low resolution images;
at least one processor; and
at least one memory including instructions, which when executed by the at least one processor, causes super resolution image reconstruction operations comprising:
receiving the plurality of low resolution images;
reconstructing a super resolution image using the plurality of low-resolution images, wherein the reconstructed super resolution image is noise filtered based on phase differences to remove the noise caused in part by reconstructing using the plurality of low resolution images; and
outputting the reconstructed super resolution image as a representation of the subject.

2. The system of claim 1, wherein the subpixel size is sized as a quarter of the image sensor pixel of the camera.

3. The system of claim 2, wherein the subpixel size is sized to be smaller than the quarter.

4. The system of claim 1, wherein the grating is configured as a hexagonal lattice grating, wherein a distance between centers among the openings is 10 to 500 micrometers.

5. The system of claim 1, wherein the slider is configured to move, using at least a stepper motor, the grating laterally from at least a first position, a second position, a third position, and a fourth position of the image plane of the camera.

6. The system of claim 5, wherein slider is synchronized with the camera, such that a trigger signal is sent to the camera to capture at least one low resolution image at each of the first position, the second position, the third position, and the fourth position.

7. The system of claim 1 further comprising the camera including the plurality of image sensor pixels.

8. The system of claim 7, wherein the camera comprises a high speed camera.

9. The system of claim 1, wherein the grating includes one or more registration landmarks captured in the plurality of low resolution images.

10. The system of claim 1, wherein the super resolution image reconstruction operations further comprise:
correcting the plurality of low-resolution images for flat field to compensate the plurality of low-resolution images for non-uniformities; and
forming, using the plurality of low-resolution images, a plurality of high resolution images by upscaling each low resolution image.

11. The system of claim 10, wherein the super resolution image reconstruction operations further comprises:
registering the plurality of high resolution images;
combining the plurality of high resolution images to generate a first high resolution image; and
performing a Fourier Transform on the first high resolution image to form a Fourier domain representation of the first high resolution image.

12. The system of claim 12, wherein the super resolution image reconstruction operations further comprise:
generating a second high resolution image by at least recombing the plurality of low-resolution images based on a high-resolution grid; and
performing a Fourier Transform on the second high resolution image to form a Fourier domain representation of the second high resolution image.

13. The system of claim 12, wherein the noise being filtered is determined based on phase differences between the Fourier domain representation of the first high resolution image and the Fourier Transform on the second high resolution image.

14. The system of claim 1, wherein the subject comprises a dynamic flow.

15. A method comprising:
generating, by an illumination source, light;
passing the light through a grating, wherein the grating forms structured illumination configured to provide sub-pixel sized structured illumination on a subject, wherein the grating is configured to move laterally along an image plane of a camera to capture a plurality of low resolution images, wherein the grating is configured to include a plurality of openings, wherein each of the openings is subpixel in size, wherein the subpixel size is smaller than an image sensor pixel of the camera;
receiving the plurality of low resolution images;
reconstructing a super resolution image using the plurality of low-resolution images, wherein the reconstructed super resolution image is noise filtered based on phase differences to remove the noise caused in part by reconstructing using the plurality of low resolution images; and
outputting the reconstructed super resolution image as a representation of the subject.

16. The method of claim 15, further comprising moving, by a slider, the grating laterally along the image plane of the camera;

17. The method of claim 16, wherein the slider is coupled to the grating and is configured to move, using at least a stepper motor, the grating laterally from at least a first position, a second position, a third position, and a fourth position of the image plane of the camera.

18. The method of claim 17, wherein slider is synchronized with the camera, such that a trigger signal is sent to the camera to capture at least one low resolution images at each of the first position, the second position, the third position, and the fourth position.

19. The method of claim 15 further comprising:
correcting the plurality of low-resolution images for flat field to compensate the plurality of low-resolution images for non-uniformities;
forming, using the plurality of low-resolution images, a plurality of high resolution images by upscaling each low resolution image;
registering the plurality of high resolution images;
combining the plurality of high resolution images to generate a first high resolution image; and
performing a Fourier Transform on the first high resolution image to form a Fourier domain representation of the first high resolution image.

20. The method of claim 19, wherein the noise being filtered is determined based on phase differences between the Fourier domain representation of the first high resolution image and the Fourier Transform on the second high resolution image.
